(19) United States
(12) Patent Application Publication
(10) Pub. No.: US 2011/0016222 A1
(43) Pub. Date: Jan. 20, 2011

(54) NETWORK ELEMENT FOR ENABLING A USER OF AN IPTV SYSTEM TO OBTAIN MEDIA STREAM FROM A SURVEILLANCE SYSTEM AND CORRESPONDING METHOD

(76) Inventors: Sanyan Gu, Shanghai (CN); Bo Huang, Shanghai (CN); Huibing Ping, Shanghai (CN); Tieying Xuan, Shanghai (CN)

Correspondence Address: FAY SHARPE/LUCENT, 1228 Euclid Avenue, 5th Floor, The Halle Building, Cleveland, OH, 44115-1843, US

(21) Appl. No.: 12/922,900

(22) PCT Filed: Mar. 18, 2008
(86) PCT No.: PCT/CN08/00532

§ 371 Date: Sep. 16, 2010

(51) Int. Cl. G06F 15/16

(52) U.S. Cl. 709/231

(57) ABSTRACT

It is proposed a network element for enabling a user of an IPTV system to obtain media stream from a surveillance system and a corresponding method. Said network element comprises: a message processing means for translating a first message for obtaining media stream from said surveillance system upon receiving said first message from said IPTV system and forwarding the translated first message to a second server in said surveillance system; and a media transfer means for transferring media stream sent from said second server to said IPTV system.

### FIELD OF THE INVENTION

The present invention relates to the field of communication, and more particularly to enabling a user of an IPTV system to obtain media stream from a video surveillance system.

### BACKGROUND OF THE INVENTION

At present, the video surveillance system is widely used in various fields or industries. An example of this kind of system is the ViSS (Video Intelligent Surveillance System) which is developed by Alcatel Shanghai Bell Co., Ltd. The ViSS is a broadband network based intelligent remote surveillance, transmission and management system, which meets the requirements for large scale carrier class video surveillance, remote access and centralized management.

FIG. 1 shows the architecture of ViSS. As shown, the ViSS is mainly composed of the following entities:
EMS: End-user Management Server, which shall provide the unique access portal and open to the end-user, including normal user and administrative user, for core network accessing capability;
CSG: Control Signaling Gateway, which shall accept the controlling command from the end-user, which could be an administrative user, and connect to video server to finish the command. The component could also accept the reporting information from the video server and report to the EMS Server;
SA: Storage Agent, which shall accept the command from the EMS and act as client agent to access and record the specific video stream into persistent storage;
SMG: Stream Media Gateway, which shall proxy the end-user requests on stream accessing and connect to front-end video server, and distribute the stream from the video server to the end-user and apply stream controlling policy inside;
Radius Server: AAA server, which implements authentication, authorization and accounting function;
Management/Surveillance Client: PC client, which includes management and surveillance client; and
DVS/DVR: Video Server, which provides video source for the ViSS solution.

In fact, the ViSS solution only adapts to PC terminals, which is not convenient in some situations, for example in which many housewives cannot operate the computer, but they hope to know if their babies are in a good way in the kindergarten by real time video on TV, or in which the hotels wish to provide their guests the real time landscape view on their TV terminal, etc. However, the IPTV (Internet Protocol Television) can provide them with convenient terminals. As known, the IPTV delivers television programming to households via a broadband connection using Internet protocols. It requires a subscription and IPTV set-top box, and offers key advantages over existing TV cable and satellite technologies. IPTV is typically bundled with other services like Video on Demand (VOD), voice over IP (VOIP) or digital phone, and Web access, collectively referred to as Triple Play.

### SUMMARY OF THE INVENTION

To solve the above problem in the prior art, according to an aspect of the present invention, a network element for enabling a user of an IPTV system to obtain media stream from a surveillance system is proposed, said network element comprises: message processing means for translating a first message for obtaining media stream from said surveillance system upon receiving said first message from said IPTV system and forwarding the translated first message to a second server in said surveillance system; and media transfer means for transferring media stream sent from said second server to said IPTV system.

According another aspect of the present invention, a method for enabling a user of an IPTV system to obtain media stream from a surveillance system is proposed, the method comprises: said network element translates a first message for obtaining media stream from said surveillance system upon receiving said first message from said IPTV system and forwards the translated first message to a second server in said surveillance system; and said network element transfers media stream sent from said second server to said IPTV system.

### BRIEF DESCRIPTION OF THE DRAWINGS

These and many other features and advantages of the present invention will become apparent from the following description of the embodiments of the present invention with reference to the drawings, wherein:

FIG. 1 shows the general architecture of an existing ViSS;

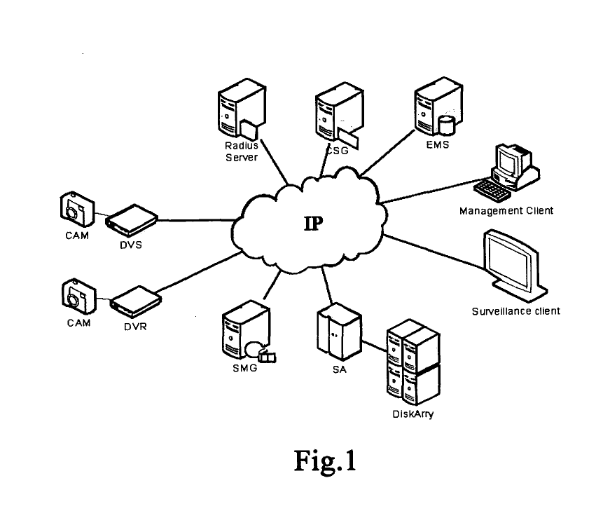

FIG. 2 illustrates the basic idea of the present invention;

FIG. 3 is a flowchart of the method according to an embodiment of the present invention;

FIG. 4 is a flowchart of signaling exchanged between the IPTV and the ViSS according to the embodiment of the present invention; and

FIG. 5 is a block diagram of the network element according to an embodiment of the present invention.

### DETAILED DESCRIPTION OF THE INVENTION

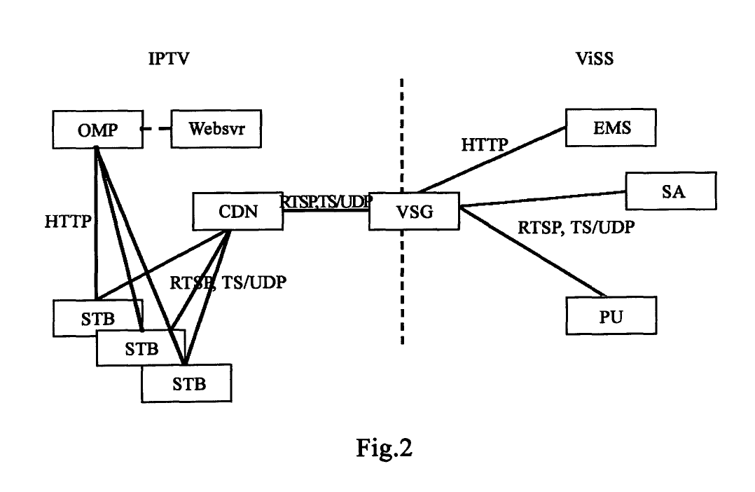

The present invention proposes a method for enabling a user of an IPTV system to obtain media stream from a surveillance system. This method may be for example applied to the system shown in FIG. 2. With reference to FIG. 2, the basic idea of the present invention is illustrated.

As shown in FIG. 2, a VSG (Video Streaming Gateway) is provided between the IPTV and the ViSS. With this VSG, the IPTV user (STB, Set-Top Box) can select the ViSS program on TV-Portal and then watch the real time video on W.

The main function of VSG is to transfer video streaming from the video server (PU, Peripheral Unit) to the IPTV system, and preferably to collect and proxy authentication and accounting information for the Radius server. When the CDN (Content Delivery network) in IPTV system receives the video surveillance content from the VSG, it will distribute the video program to different IPTV users (STB) according to IPTV distribution mode.

The main modules in VSG are these below:

1. RTSP Proxy, adapted to implement RTSP proxy function and to interpret and rewrite a RTSP request message before forwarding it;

2. Media transfer module, adapted to receive and transfer the video surveillance program from the ViSS to the IPTV, which program will be then distributed to different IPTV users by the CDN;

3. Authentication and Accounting proxy, adapted to transfer authentication information to the Radius server in the ViSS in order to authorize an IPTV user, and to collect accounting data for CDR.

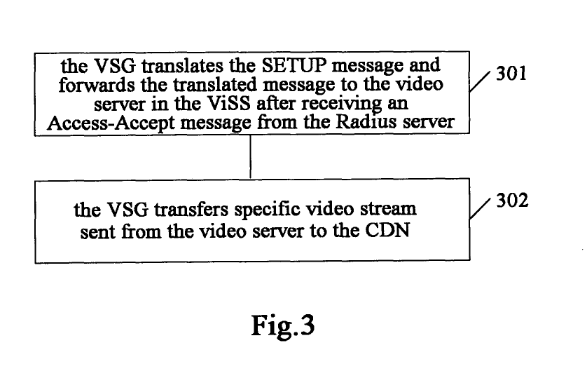

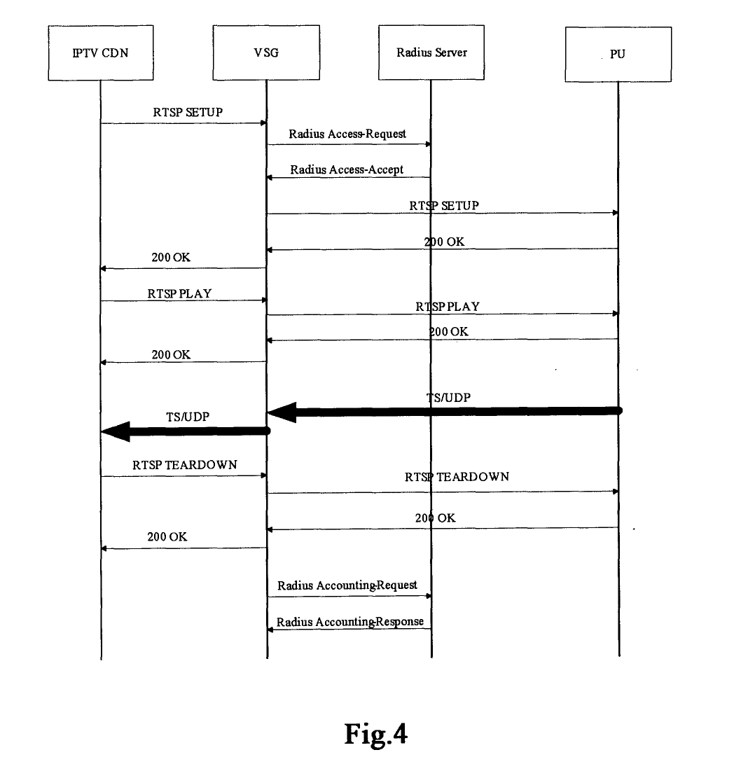

With reference to FIG. 3, the method for enabling a user of an IPTV system to obtain media stream from a surveillance system will be described hereinafter based on the system shown in FIG. 2 in combination with the flowchart of signaling of FIG. 4.

Preferably, before the method according to the present invention begins, said network element sends an authentication request to a first server in said surveillance system to authorize said user upon receiving from said IPTV system a first message for obtaining media stream from said surveillance system. Herein, as shown in FIG. 2 and FIG. 4, the surveillance system is for example a ViSS, the network element is for example a VSG, the first server is for example a Radius server, i.e. AAA server, the authentication request is for example an Access-Request message according to the Radius protocol, and the first message is for example a SETUP message according to the RTSP protocol. In this embodiment, the SETUP message is sent by the CDN in the IPTV system to the VSG to obtain video program from the ViSS. The URL format in this SETUP message is for example as follows: rtsp://vsgaddress:554/asset/service?USERID=320101312345670001&Password=abdcdef&ChanelNo-PUID=1-320101000200000001&PlayMethod=0, which means that user 320101312345670001 wants to watch Real-time video program in the first channel of 320101000200000001. Then the VSG will send a Radius Access-Request message to the Radius server in the ViSS for the purpose of authentication. Conventionally, the Radius server will return a Radius Access-Accept message to the VSG as an acknowledgement.

The method of the present invention begins from step 301. In step 301, said network element translates the first message and forwards the translated first message to a second server in said surveillance system. Herein, the second server is for example a video server (PU). More particularly, in this embodiment, the VSG will analyze and rewrite the SETUP message after receiving the Radius Access-Accept message from the Radius server. The rewritten message is for example as follows: rtsp://puaddress:554/asset/service?USERID=320101312345670001&Password=abdcdef&ChanelNo-PUID=1-320101000200000001&PlayMethod=0, in which the address of the VSG is replaced by the address of the video server. Then, the VSG will forward the rewritten SETUP message to the video server.

Next, in step 302, said network element transfers media stream sent from said second server to said IPTV system. More particularly, in this embodiment, after a RTSP connection based on for example TCP being set up, the specific video stream will sent from the video server to the VSG, again from the VSG to the CDN.

With reference to FIG. 4, the video server will sent a 200 OK message in response to the rewritten SETUP message as acknowledgement. Then, the CDN will send a PLAY message, which tells the video server to start sending data via the mechanism specified in the SETUP message. After receiving from the video server a 200 OK message, the RTSP connection will be established.

In addition, if the IPTV user wants to close this video program, the CDN will send a RTSP TEARDOWN message to the VSG, and then the VSG will forward this message to the video server so as to end this session. Optionally, at the same time, the VSG also will collect and report accounting information to the Radius server with a Radius Accounting-Request message, and the Radius server will produce a CDR (Call Detail Record) for this communication and respond with a Radius Accounting-Response message to the VSG.

It should be noted that, in case that another IPTV user wants to watch the same video program, the CDN is responsible for distributing the same video content to this another user, and in this case, the CDN will not send the SETUP message to the VSG.

Thereby, with this method, by arranging an intermediate gateway between the IPTV and the ViSS to forward and translate RTSP messages, the two self-governed systems can be associated together and an IPTV user can watch the video surveillance contents from the ViSS on TV. Furthermore, since there is no need to modify the networks of the IPTV and ViSS, this solution can be implemented efficiently and economically.

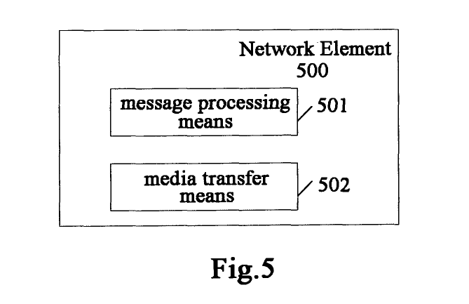

Based on the same inventive concept, according to another aspect of the present invention, a network element for enabling a user of an IPTV system to obtain media stream from a surveillance system is proposed. The network element will be described in the following with reference to FIG. 5.

FIG. 5 is a block diagram of the network element according to an embodiment of the present invention, which is for example a VSG as shown in FIG. 2. The network element 500 includes a message processing means 501 and a media transfer means 502. Preferably, the network element 500 includes also an authentication means (not shown) and an accounting means (not shown).

With reference to FIG. 4, preferably, when a SETUP message is sent by the CDN to the VSG, the authentication means will send a Radius Access-Request message to the Radius server for authentication and the Radius server will return back a Radius Access-Accept message as an acknowledgement. The URL format in this SETUP message is for example as follows: rtsp://vsgaddress:554/asset/service?USERID=320101312345670001&Password=abdcdef&ChanelNo-PUID=1-320101000200000001&PlayMethod=0, which means that user 320101312345670001 wants to watch Real-time video program in the first channel of 320101000200000001. Then, the message processing means 501 will analyze and rewrite the SETUP message after receiving the Radius Access-Accept message from the Radius server. The rewritten message is for example as follows: rtsp://puaddress:554/asset/service?USERID=320101312345670001&Password=abdcdef&ChanelNo-PUID=1-320101000200000001&PlayMethod=0, in which the address of the VSG is replaced by the address of the video server. Then, the message processing means 501 will forward the rewritten SETUP message to the video server. The video server will sent a 200 OK message in response to the rewritten SETUP message as acknowledgement. Then, the CDN will send a PLAY message. After receiving from the video server a 200 OK message, the RTSP connection will be established. Thus, the specific video stream will sent from the video server to the VSG, and the media transfer means 502 will forward this video stream to the CDN.

Optionally, after the RTSP connection being cleared up, the accounting means will collect and report accounting information to the Radius server with a Radius Accounting-Request message, and the Radius server will produce a CDR for this communication and respond with a Radius Accounting-Response message to the VSG.

It should be noted that, in case that another IPTV user wants to watch the same video program, the CDN is responsible for distributing the same video content to this another user, and in this situation, the CDN will not send the SETUP message to the VSG.

In implementation, the network element 500 of this embodiment as well as the message processing means 501, the media transfer means 502, the authentication means and the accounting means it includes, may be implemented in software, hardware or a combination of them. For example, those skilled in the art are familiar with a variety of devices which may be used to implement these components, such as micro-processor, micro-controller, ASIC, PLD and/or FPGA etc. The message processing means 501, the media transfer means 502, the authentication means and the accounting means of the present embodiment may be implemented separately physically but interconnected operatively.

In operation, said network element of the embodiment illustrated in connection with FIG. 5, can associate the IPTV with the ViSS by forwarding and translating RTSP messages and therefore enable an IPTV user to watch the video surveillance contents from the ViSS on TV. Furthermore, since there is no need to modify the networks of the IPTV and ViSS, this solution can be implemented efficiently and economically.

Although the exemplary embodiments of the method and the network element for enabling a user of an IPTV system to obtain media stream from a surveillance system of the present invention are described above in detail, the above embodiments are not exhaustive, and those skilled in the art can make numerous changes and modifications within the spirit and scope of the present invention. Therefore, the present invention is not limited to those embodiments, the scope of which is defined only by the appended claims.

1. A network element for enabling a user of an IPTV system to obtain media stream from a surveillance system, wherein said network element is arranged between the IPTV system and the surveillance system, said network element comprising:
message processing means for translating a first message for obtaining media stream from said surveillance system upon receiving said first message from said IPTV system and forwarding the translated first message to a second server in said surveillance system; and
media transfer means for transferring media stream sent from said second server to said IPTV system.

2. The network element according to claim 1, wherein said first message is a SETUP message according to the RTSP protocol.

3. The network element according to claim 1, wherein said second server is a media server.

4. The network element according to claim 1, further comprising authentication and accounting means for sending an authentication request to a first server in said surveillance system to authorize said user upon receiving from said IPTV system said first message and before processing said first message, and for collecting and reporting accounting information to said first server after receiving from said IPTV system a second message for clearing up connection set up between the IPTV system and the surveillance system.

5. The network element according to claim 4, wherein said first server is an authentication, authorization and accounting server.

6. The network element according to claim 4, wherein said authentication request is an Access-Request message according to the Radius protocol, and said second message is a TEARDOWN message according to the RTSP protocol.

7. The network element according to claim 1, wherein translating the first message includes replacing the address of said network element in the first message by address of said second server.

8. A method for enabling a user of an IPTV system to obtain media stream from a surveillance system via a network element, wherein said network element is arranged between the IPTV system and the surveillance system, the method comprising:
said network element translating a first message for obtaining media stream from said surveillance system upon receiving said first message from said IPTV system and forwarding the translated first message to a second server in said surveillance system; and
said network element transferring media stream sent from said second server to said IPTV system.

9. The method according to claim 8, wherein said first message is a SETUP message according to the RTSP protocol.

10. The method according to claim 8, wherein said second server is a media server.

11. The method according to claim 8, further comprising said network element sending an authentication request to a first server in said surveillance system to authorize said user upon receiving from said IPTV system said first message and before processing said first message, and collecting and reporting accounting information to said first server after receiving from said IPTV system a second message for clearing up connection set up between said IPTV system and said surveillance system.

12. The method according to claim 11, wherein said first server is an authentication, authorization and accounting server.

13. The method according to claim 11, wherein said authentication request is an Access-Request message according to the Radius protocol, and said second message is a TEARDOWN message according to the RTSP protocol.

14. The method according to claim 8, wherein translating the first message includes replacing the address of said network element in the first message by address of said second server.
